(19) United States
(12) Patent Application Publication
(10) Pub. No.: US 2007/0058637 A1
(43) Pub. Date: Mar. 15, 2007

(54) Method for multi-channel multi-device call transfer

(76) Inventor: Tun Han Felix Lo, Hong Kong (CN)

Correspondence Address: KNOBBE MARTENS OLSON & BEAR LLP, 2040 MAIN STREET, FOURTEENTH FLOOR, IRVINE, CA, 92614, US

(21) Appl. No.: 11/227,407

(22) Filed: Sep. 14, 2005

(51) Int. Cl. H04L 12/28

(52) U.S. Cl. 370/395.2

(57) ABSTRACT

A method of improving communication in a SIP-enabled communication network which involve a variety of communication devices. By the method, a call, either entirely or just a selected medium stream of the call, may be switched, easily and seamlessly to a different channel for different media, either on the same device or on a separate device connected to the network, either during call-setup or after a call session has been established. The call may also initiate a application sharing session so that caller, callee and those participated in the call (in conference mode) may see the content of the same document or whiteboard on a screen while keeping voice communication over the phone.

### BACKGROUND OF THE INVENTION

1. Field of the Invention

This invention relates to a method for a call session transfer and call-setup forwarding among communication devices. Particularly, it relates to a method for redirecting, splitting and reestablishing a communication session (or a call) in a heterogeneous environment involving various types of media and various types of communication devices connected through a session initiation protocol (SIP)-enabled communication network.

2. Description of the Related Art

Traditional PBX (Private Branch Exchange) phone system involves only voice or video in a fairly homogeneous environment. While some PBX's have incorporated instant messaging and other data communication methods into their features and services, they have so far failed to take different types of media streams and a wide variety of communication devices into their consideration in designing and enhancing telephony products and services. While some online chat systems have implemented new features through presence and instant messaging, these systems have not fully taken advantages of the possibilities of integrating their new features with traditional telephony features and services in a seamless fashion.

Therefore, the need exists for bridging the two communication worlds, the world of traditional telephony and the world of modem data communication, and creating a communication platform that combines voice communication, instant messaging, document sharing, video communication, operating in a point-to-point mode or in a conferencing mode, in a heterogeneous environment comprising various types of communication devices.

### SUMMARY OF THE INVENTION

A method of improving communication in a SIP-enabled communication network is discussed whereby a call-initialization offer may be re-directed or an existing call session may be re-established seamlessly among participating communication devices which, based on different technologies, can support various channels to accommodate different medium streams. This method of call redirection and session re-establishment in such a heterogeneous environment can be accomplished by software modules integrated in participating communication devices.

The method is suitable to SIP-enabled communication networks, which include, for example, 3rd Generation (3G) Mobile System, General Packet Radio Service (GPRS), voice over Wireless Fidelity (WiFi), voice over Wireless Metropolitan Area Network (WiMax), or Voice over Internet Protocol (VoIP) in a Broadband or Local Area Network. Those are essentially IP networks. Non-IP based networks as an equivalent, however, may be suitable for practicing the method as well, albeit with a different protocol design. The communication endpoints in a SIP-enabled network may be an IP phone, a mobile phone, a Personal Digital Assistant (PDA), or any communication devices.

In one embodiment, there is a method of improving communication flow during the call-setup stage in a SIP-enabled communication network with at least a first communication device being used by a caller and a second communication device being used by a callee, comprising:
(a) sending a SIP message from said first communication device to initiate a call to said second communication device;
(b) presenting or displaying on said second communication device a plurality of choices, which are in addition to the conventional options of accepting a call, rejecting a call, and call-waiting, at one or more navigating levels for said callee to select from upon notification of said call; and
(c) sending another SIP message or a provisional SIP response from said second communication device in responding to said call, the content of said SIP message or provisional SIP response depending on the selection of said choices made by said callee.

The call may continue in the following various fashions:

(1) Depending on the choice selected in (b), a caller may have another set of choices presented to decide upon the final means of communication channel or other options such as leaving a voice mail.

(2) Depending on the choice selected in (b) and in (1), a call session may be established in a different channel from the default channel of communication. For example, if the callee is busy on the voice channel talking with a first caller, the callee may choose to establish the call in a text messaging channel to communicate with the second caller with text messages.

Once the call has been established, either by a normal call-setup procedure or by the aforementioned call-setup procedure,

(3) The established call session may be switched by either the caller or callee to a different channel on the same communication device. Continuing the example in (2), when finishing the call with the first caller, the callee may decide to switch the messaging session back to voice call.

(4) The established call session may be transferred to a separate communication device either belonging to the end users or to another party with an automatic adjustment of default channel of communication. For example, a default channel of voice communication is first established between a communication device supporting voice and video, and a second communication device supporting only voice. The user of the second communication device may transfer this established call session to another device that supports both voice and video. The new default channel after the transfer may now be in both voice and video.

(5) Part of the established call session (one or more digital data streams), not all the data streams of the call session, may be transferred to a separate communication device either belonging to the end user or to another party. For example, the end user may decide to transfer the video stream of a video phone call to a TV or computer monitor while keeping the voice session on the video phone. It can be incorporated into the speaker phone functionality of a video phone, as the larger screen on a TV may be preferable when several users are involved on a speaker phone. The separate communication device may accommodate the following selections of digital data streams: text only (such as instant messaging), audio only (voice call), video only, text+audio, audio+video (such as video phone call), text+video, text+video+audio, etc. The separate communication device to which the call is transferred to may be another communication phone, a desktop phone, a desktop or laptop computer, a TV set or any device that supports the SIP protocol. Conventional devices, such as a TV set, may be made SIP compliant through the use of a set-top box.

(6) The establishment and the transfer or re-establishment of a call session may initiate an application sharing session on a separate or remote communication device capable of running software applications, whereby a call may accompanied by network games, a whiteboard, sharing word documents or other electronic files.

(7) The establishment and the transfer of a call session may initiate an application sharing session on a separate or remote communication device capable of running network games, whereby a call may be accompanied by a network game session.

Of course, for a particular communication session, one does not need all the features listed above. Similarly for a particular communication device used, one does not need to implement all the above features. The above features are provided as examples, and not limitations to the method.

The various features of novelty which characterize the embodiments are pointed out with particularity in the claims annexed to and forming a part of this disclosure. For a better understanding of the embodiments, its operating advantages, and specific objects attained by its use, reference should be made to the drawings and the following description in which there are illustrated and described preferred embodiments.

### BRIEF DESCRIPTION OF THE DRAWINGS

FIG. 1 is an exemplary display panel on a callee's communication device during an incoming call, showing choices of traditional call waiting, rejecting call, and indication of availability for an instant messaging session.

FIG. 2 is an exemplary display panel on a caller's communication device after the callee has picked the preferred option, showing choices of accepting the callee's suggestion to chat in an instant messaging session, or leaving a text mail, voice mail, or video mail.

FIG. 3 shows a possible useful message on the display panel on a caller's communication device after an IM session has been established.

FIG. 4 is an exemplary display panel on a callee's communication device showing that the caller has decided to leave a video mail instead of IM session.

FIG. 5 provides an example of a call flow for the collective choice of instant messaging as the final communication means.

FIG. 6 provides an example of a call flow for the final choice of leaving a video mail.

FIG. 7 is an example of a 380 Alternative Response with XML body such as corresponding to the call flow of FIG. 6.

FIG. 8 is an example of Callee preferences.

FIG. 9 is an exemplary display panel on a communication device during a voice session, showing choices in switching the communication mode.

FIG. 10 is an exemplary display panel on a communication device illustrating the process of transferring from one device to another.

FIG. 11 is an exemplary display panel on a communication device illustrating the process of application sharing.

FIG. 12 provides an example of a call flow for switching communication mode on the same device.

FIG. 13 provides an example of a call flow for switching from an audio call to a video+audio call.

FIG. 14 is an exemplary REFER message for a multi-channel transfer.

FIG. 15 provides an example of a call flow for transferring a call among different devices.

FIG. 16 provides an example of a call flow for transferring a video stream onto TV.

FIG. 17 provides an example of a call flow for initiating an application sharing session.

FIG. 18 is an exemplary REFER message for transferring applications or games.

FIG. 19 provides another example of a call flow for initiating application sharing session.

FIG. 20 shows examples of device Uniform Resource Identifier (URI) mapping.

FIG. 21 provides an example of a call flow for multi-channel transfer through a service provider.

FIG. 22 shows examples of a device URI mapping and translation.

### DETAILED DESCRIPTION OF CERTAIN EMBODIMENTS

Switching Mode of Communication

Certain embodiments enhance a call transfer and a call forwarding redirection so that the original call may be transferred and forwarded not just to the traditional voice only communication device but also to devices with multi-channels accommodating different communication media, such as text, audio, video, application files, etc, in a wide variety of possibilities.

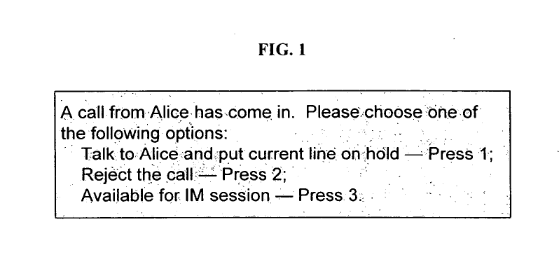

Referring to FIG. 1, a callee may choose different options in addition to the standard options of accepting calls, rejecting calls, or call waiting. For instance, Bob may be talking to David on the phone when Alice calls Bob. In one embodiment, the communication device then provides Bob with three options to choose from.
First choice is to switch to Alice line;
Second choice is to reject Alice's call;
Third choice is to make oneself available for chatting through an instant messaging session.

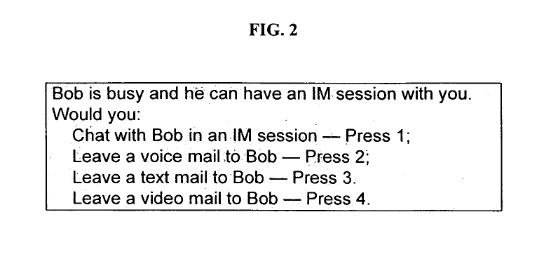

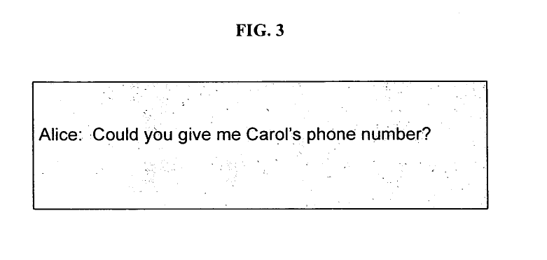

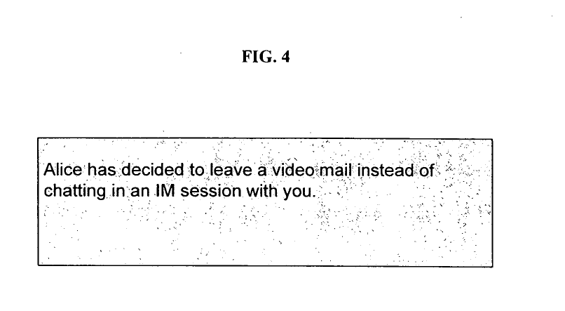

If Bob chooses the third option, Alice will see a display, such as on a LCD, in FIG. 2 if Alice has voice/text/video mail feature provisioned. If Alice chooses option one (chatting with Bob in an IM session), the instant messaging session would start immediately, as in FIG. 3. If Alice chooses to leave a message, such as video mail, Bob will be notified that Alice has chosen to leave a video mail rather than talking through instant messaging. Then Bob's LCD display will be displayed as in FIG. 4.

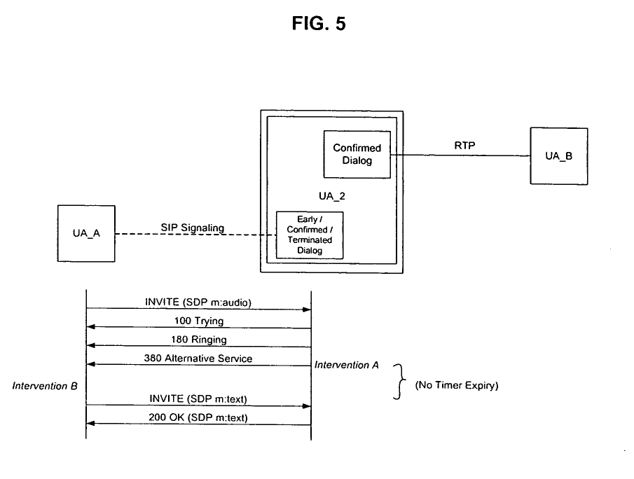

FIG. 5 shows an example SIP Message flow if Bob chooses the “available for instant-messaging” option. UA_2 will send a “380 Alternative Service” response to UA_A. In one embodiment, the contact lists include all the available services. These services include:
<sips:bob@(biloxi.example.com>
   instant messaging service option
<sips:bob@mediaserver.example.com; type=text>
   text mail option
<sips:bob@mediaserver.example.com; type=audio>
   voice mail option
<sips:bob@(mediaserver.example.com; type=video>
   video mail option

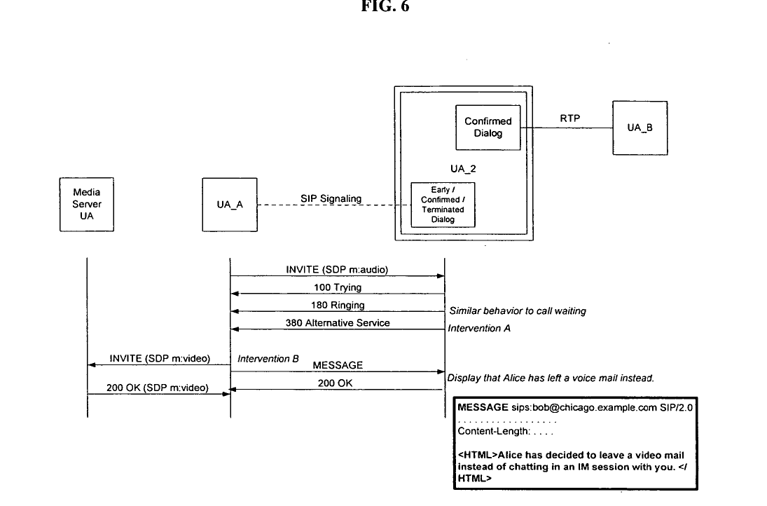

FIG. 6 shows an example SIP Message flow if the caller (Alice) chooses to leave a video mail, after the callee (Bob) has already chosen to make himself available for instant messaging. When Alice makes the choice, the UA_A will send an INVITE to the media server, with audio as the media. At the same time, UA_A will send a MESSAGE indicating that Alice has decided to leave a voice mail instead of starting an instant messaging conversation.

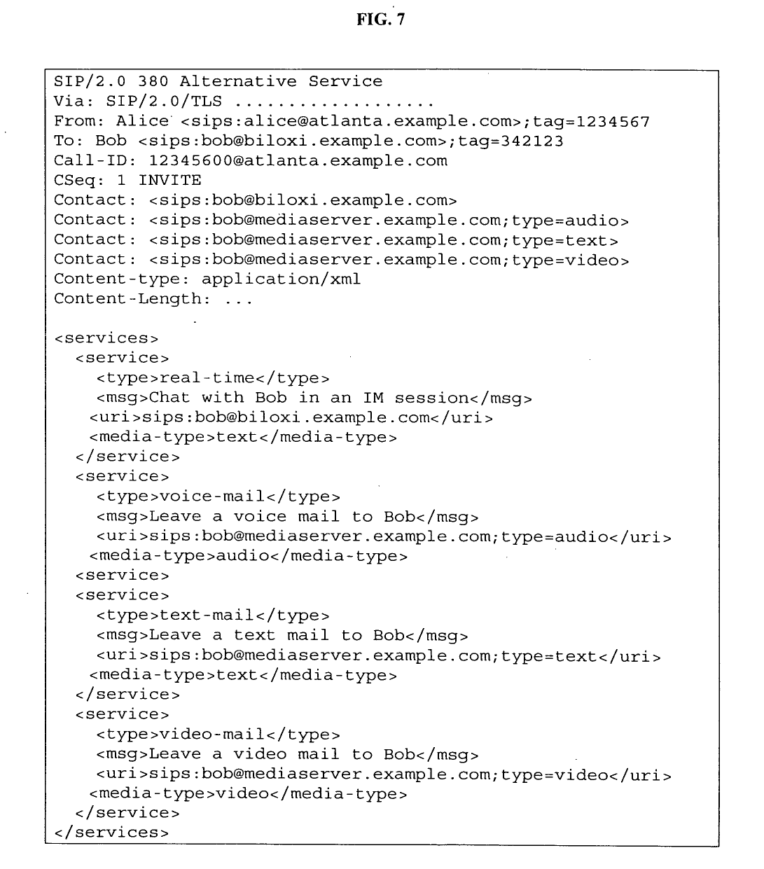

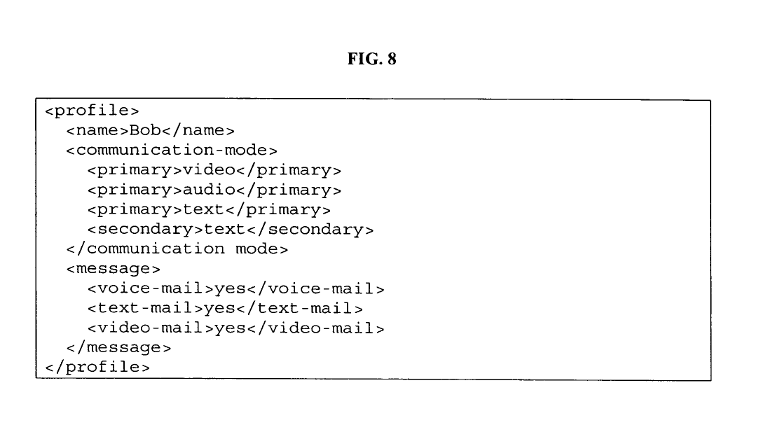

FIG. 7 shows an example of a 380 Alternative Service response. The XML body indicates the available services that UA_A will display for Alice. Since proxy is not allowed to modify the body of a message, UA_2 needs to have Bob's profile pre-downloaded. Bob's profile may contain the entries depicted in FIG. 8.

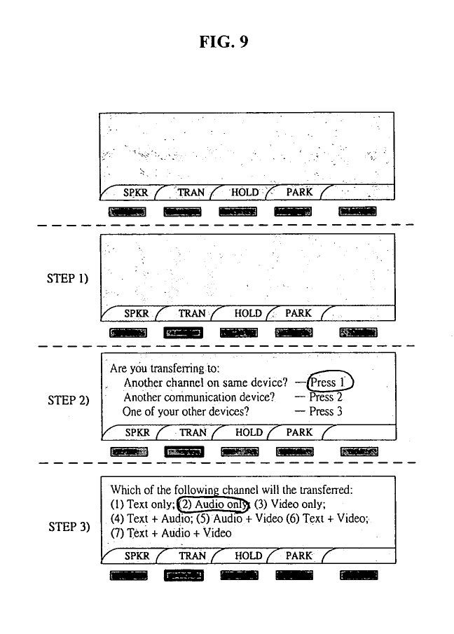

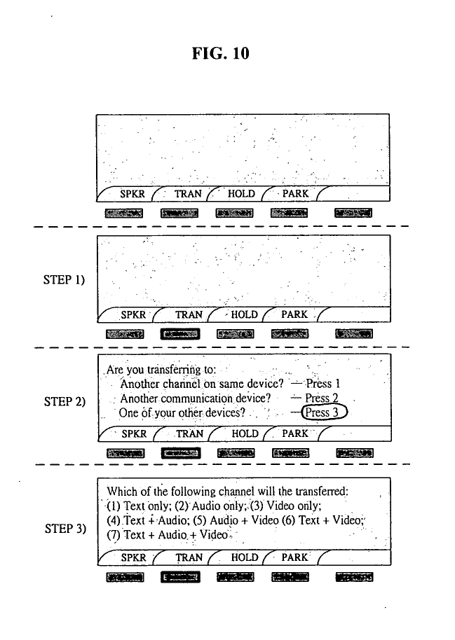

Once a call has been established, a user may want to switch among different modes of communication. For instance, referring to FIG. 9, Bob may be talking to David on the phone while chatting with Alice on an instant messaging session. After the call with David has ended, Bob wants to “upgrade” his chat session to a voice communication session. FIG. 9 and FIG. 10 provide sample user interfaces displayed on a communication device that would cover those possible scenarios.

FIG. 9 shows the steps that Bob may undertake to achieve his purpose:
Step 1): Press the <Transfer> Key
Step 2): Press key <1> (choosing “Another Channel on the same device”)
Step 3) Press key <2> (choosing “Audio only”)

As examples, the following modes are available to choose from in Step 3:
Text only
Audio only
Video only
Text+Audio
Audio+Video
Text+Video
Text+Audio+Video

“Video only” means video with no audio. This may be used in certain situations, for example, when the caller and callee want to keep each others on video after finishing their voice communication. “Audio+Video” means a video phone call. “Text+Audio”, or “Text+Audio+Video” means combination of instant messaging with a typical voice-only phone call or video phone call. “Text+Video” means an instant messaging session with no voice communication, but with video exchanges. Sometimes it is much more efficient using this text channel to pass information, such as phone number or address, to each other.

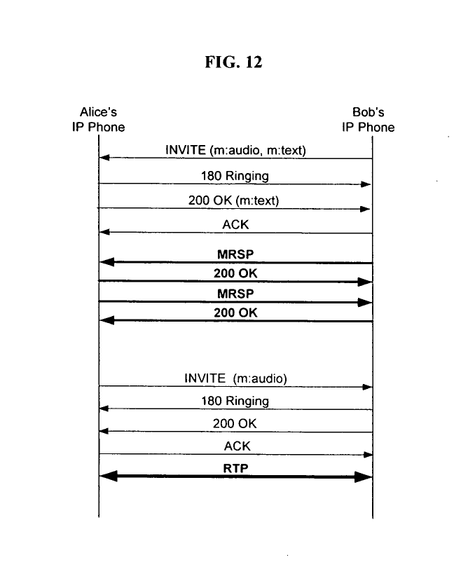

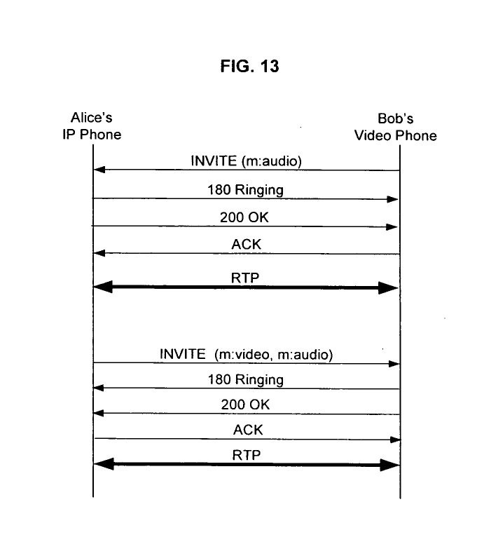

As a particular embodiment using SIP messages, the communication mode can be switched on the same device by sending a re-INVITE to convert the session. FIG. 12 shows the case where an instant messaging session is switched to an audio session. In the initial call, Alice is unavailable for the audio session, and decides to chat with Bob on an instant messaging session. Several minutes later, Alice becomes available on the audio channel and decides to switch back to an audio session. When Alice chooses to switch mode, a re-INVITE is sent from Alice's phone to Bob's phone to establish a Real-time Transport Protocol (RTP) channel for the voice session. Similarly, FIG. 13 shows a call flow example used to switch from an audio call to a video+audio call on the same device.

Transferring from One Device to Another

A user may transfer the call from one device to another in a different communication mode. If the call is transferring to a device not belonging to the user, the callee can press <2> in Step 2, and the behavior would be similar to traditional call transfer. If the call is transferring to the user's other devices, the callee can press <3> in Step 2, as depicted in FIG. 10. In this way, the callee may choose to transfer the call to the following personal device as he or she deems suitable:
Mobile Phone
Desktop Phone
PC
TV
   The above listed personal devices are intended to serve as examples and other communications device may be used to obtain satisfactory results. Furthermore, the callee may choose to transfer one or more selective channels to another device. For example, the callee may want to transfer only the video to the TV while retaining the voice channel on the desktop phone.

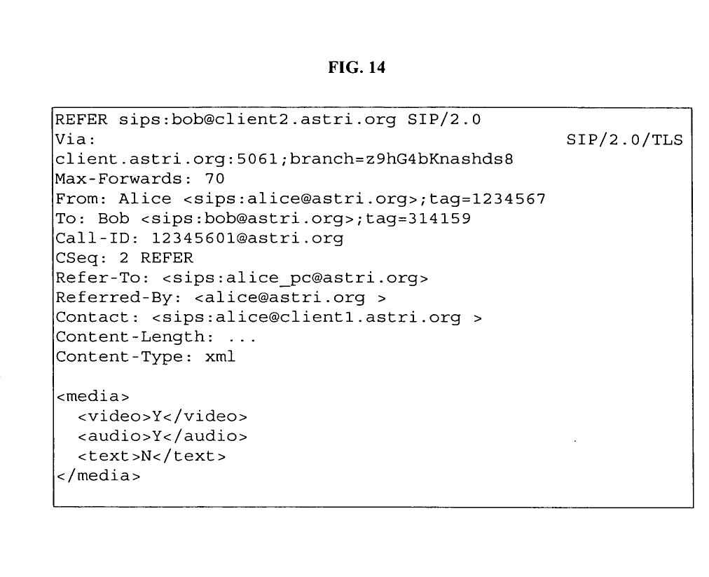

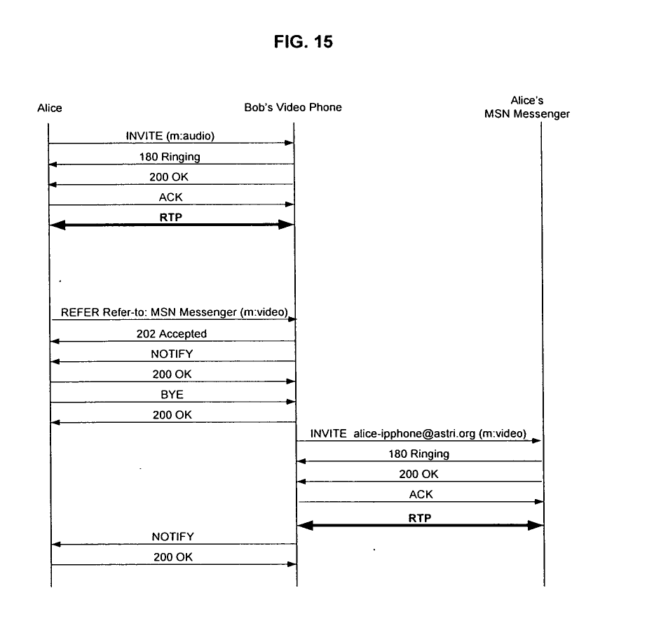

As a specific embodiment, to transfer calls among devices, a REFER (a SIP request with method Refer as defined in RFC 3515) is used in the same way as traditional call transfer (see FIG. 15) but without being limited to voice-only transfer. Rather, the transfer may be between a voice call and a video call. To convey the additional information on the selected media that needs to be conveyed, the REFER message is extended to include an XML message, specifying the selected media that is being transferred. An exemplary REFER message from the transfer call-flow example is shown in FIG. 14. If the XML has video enabled and voice disabled, then the remote party will only see the video from the web cam, but receive no audio signal anymore. If the remote user has been using a stand-alone phone for the voice channel and a computer application for the video channel, then the remote user can now hang up the phone and each user watches the other through the web cams and applications.

Splitting a Call into several Medium Streams

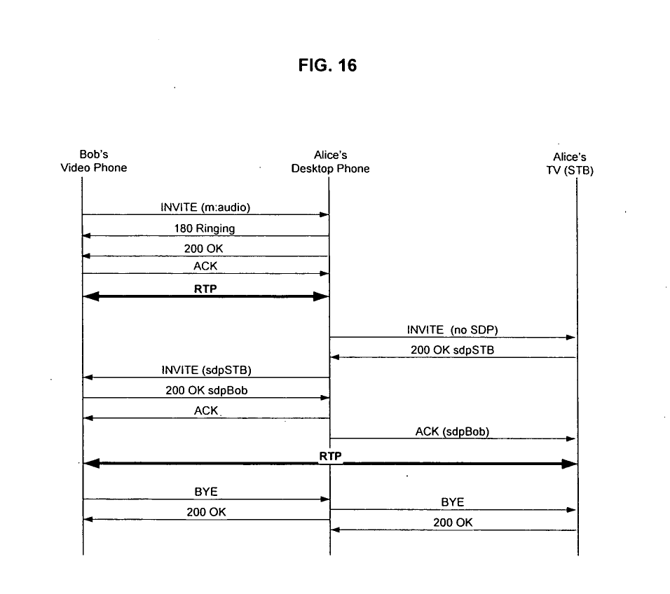

An end-user may split a call into several medium streams and transfer only some of them while retaining the remaining. For example, for transferring only selected media instead of the whole call, the call-flow will be based on a re-INVITE instead of a REFER, as shown in FIG. 16. This differs from the transferring a call as discussed above where the initial call session would be torn down, while call splitting here would keep the initial call session.

Starting Application Sharing Session on a Remote Machine

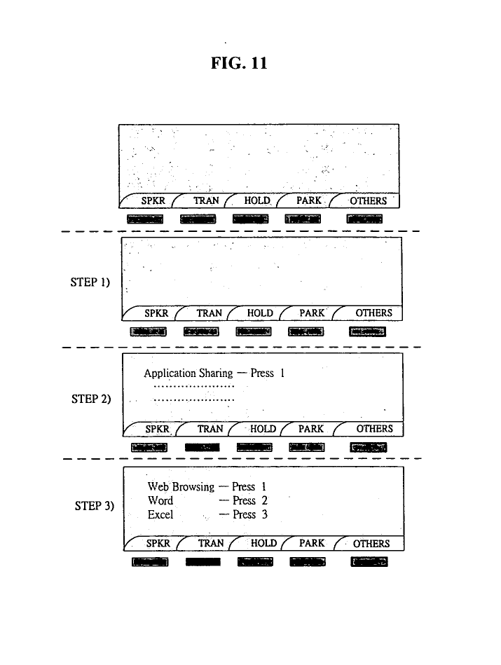

The caller or callee in practicing the method may start an application sharing session on separate SIP-enabled communication devices that are connected to the communication network and capable of executing and running software applications. Based on a certain SIP call flow, they can trigger the sharing of a word document or a white-boarding session from the SIP phone. FIG. 11 shows a sample user interface of triggering an application sharing. It assumes that the IP address of the remote PC has already been configured at boot-up time.

An application sharing session on a PC may be initiated using the same call-flow in SIP as those used in partially transferring a split call. The difference is only in the media protocol, e.g., changing from RTP to either T.120 (for whiteboard or file transfer) or T.128 (for other application sharing, such as word or remote desktop).

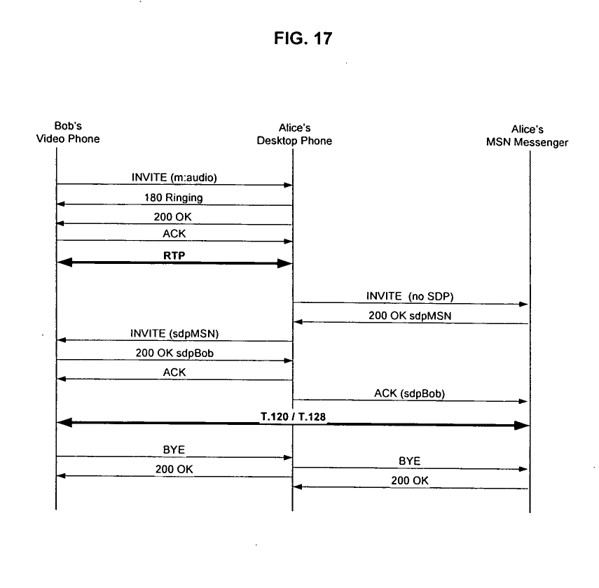

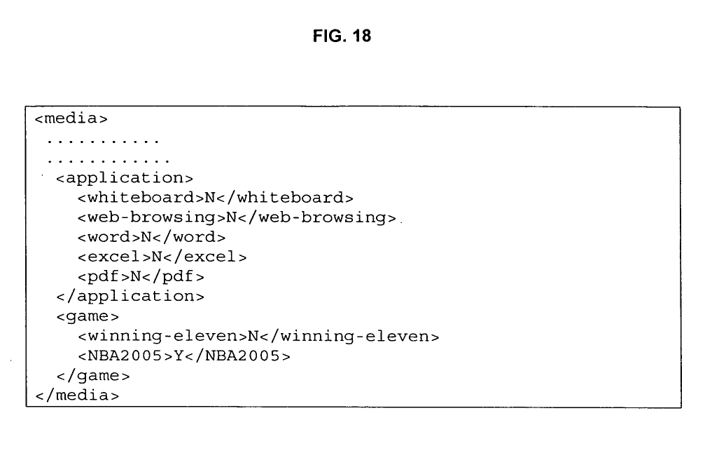

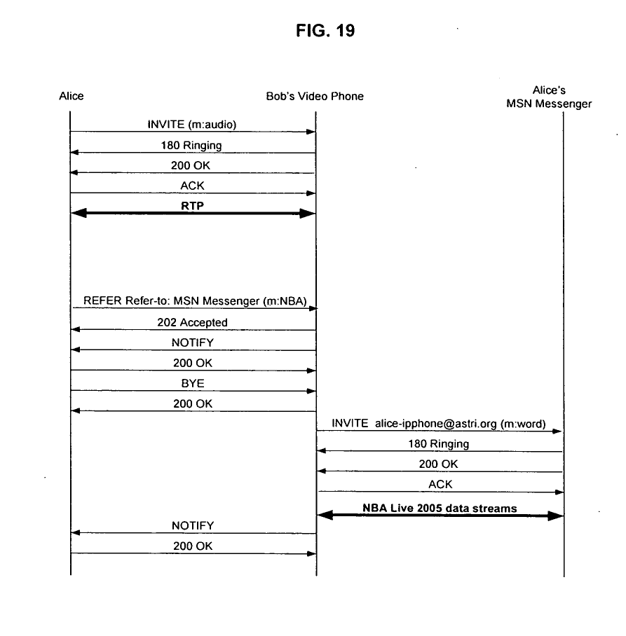

Referring to FIG. 17, for an option where Alice's voice call drops immediately after starting the application sharing or network games, the call-flow will be identical to a call transfer. Meanwhile, the REFER body would require some additional fields. FIG. 18 and FIG. 19 illustrate an example of “transferring” into an NBA Live 2005 network game session.

Device URI Mapping and Translation

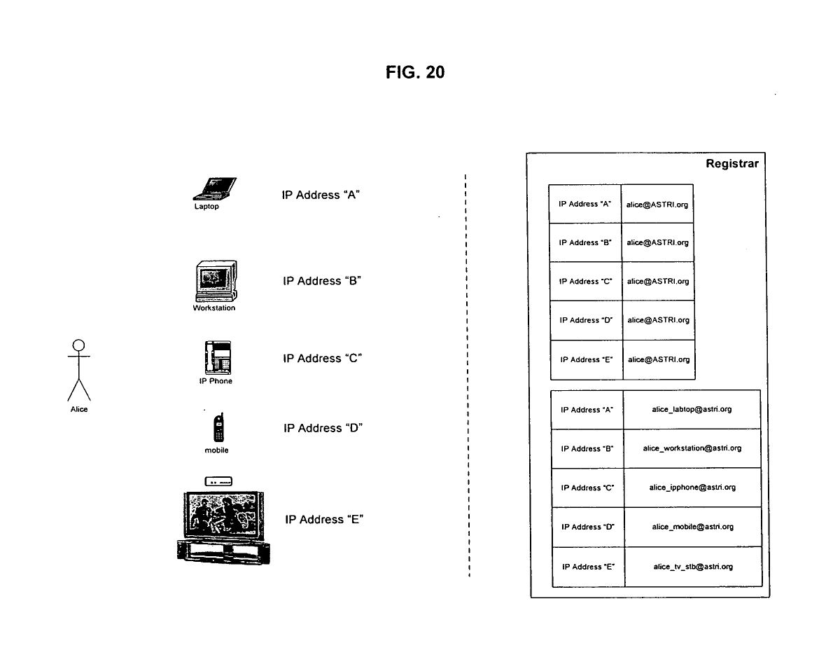

To facilitate the transfer and forwarding among different devices, each device requires a specific URI. Thus, for each device, there would be two registrations. One registration is for mapping the user's personal URI with the device's IP address. The other registration is for mapping the URI of a personal device with the device's IP address. For instance, Alice may have the URI alice@astri.org, her phone alice_phone@astri.org, and her PC alice_pc@astri.org. In this case, the rule of personal URI is “<user>_<device>@<domain-name>”. This is illustrated in FIG. 20.

There are at least three possible methods to help standardization among vendors for these URI's:
1. Using a unique URI or unique phone number for each device
2. Allow personal customization of the URI's for each device
3. Make different vendors' products interoperable through standardization or building adaptors.

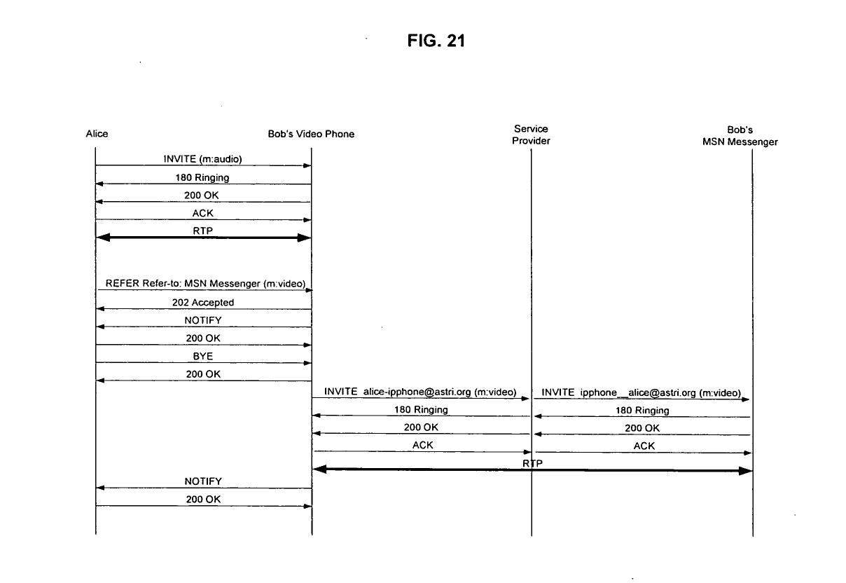

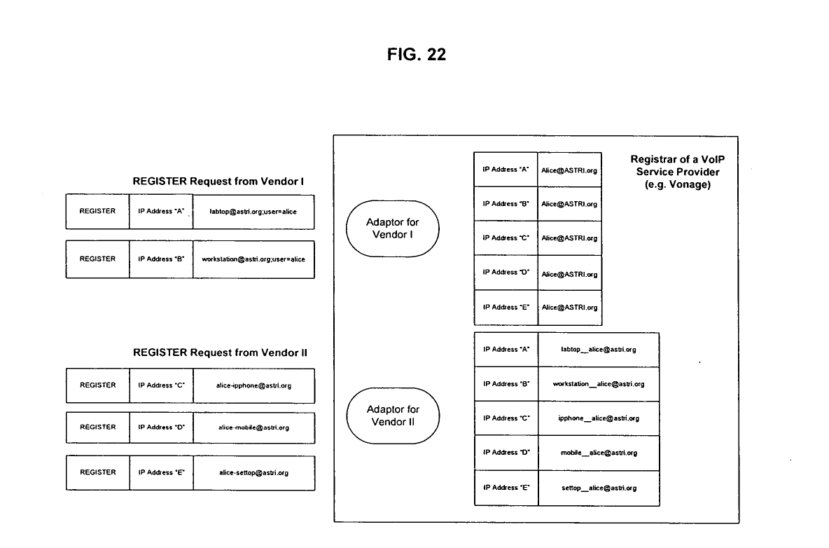

While these methods may increase the level of complexity in implementation, they also increase the level of user-friendliness. Method 1 is simplest from the implementation point of view. This assumes that the user does not mind remembering the specific phone number or URI. For instance, Alice may remember alice@hotmail.com as her MSN messenger's URI, and 93250134 as her mobile phone number. Method 2 would allow the user to configure her device's URI through the phone's LCD screen or through a web configuration. This profile configuration would be downloaded to the different devices at start-up time. Method 3 would require standardization effort or vendor-specific adaptors at the service provider. The approach is illustrated through FIG. 21 and FIG. 22.

While there have been described and pointed out fundamental novel features as applied to certain embodiments thereof, it will be understood that various omissions and substitutions and changes, in the form and details of the processes and methods illustrated, may be made by those skilled in the art without departing from the spirit of the invention. For example, it is expressly intended that all combinations of those elements of method acts which perform substantially the same function in substantially the same way to achieve the same results are within the scope of the embodiments.

The embodiments described above which are presented as examples only are not limiting but can be modified in various ways within the scope of protection defined by the appended patent claims.

In interpreting the appended patent claims, the definitions provided in the following should take precedent if they are inconsistent with descriptions elsewhere in the application.

“SIP” stands for “Session Initiation Protocol” and is a protocol developed within the IETF MMUSIC (Multiparty Multimedia Session Control) for network conferencing, telephony, presence, events notification and instant messaging. A “SIP” message is a signal that complies with the Session Initiation Protocol.

A “Mobile phone device” is a communication device that can be hand-held or carried around easily in a pocket or purse and that is capable of initiating or receiving a SIP based call through a wireless connectivity to a SIP-enabled communication network with or without a service provider. A “Communication device” is an electronic device that is capable of initiating or receiving a SIP based call through a wired or wireless connectivity to a SIP-enabled communication network with or without a service provider.

A “Caller” means a party who initiates a communication session or call to another party. A “Callee” is a party who receives a call from another party or caller. A “Call” means a communication session imitated by a caller with a callee and/or other parties (in a conference mode). A call may comprise a plurality of data streams which can be digital, analog or mixture thereof. A “Communication channel” is a function unit, implemented in software, hardware or combination thereof, on a communication device that can accommodate a call-flow but renders one or more data streams humanly understandable.

What is claimed is:

1. A method of improving communication during the call-setup stage in a SIP-enabled communication network which comprises at least a first communication device being used by a caller and a second communication device being used by callee, comprising:
sending a SIP message from said first communication device to initiate a call to said second communication device;
presenting or displaying on said second communication device a plurality of choices, which offer options other than accepting a call, rejecting a call, and call-waiting, at one or more navigating levels for said callee to select from upon notification of said call; and
sending another SIP message from said second communication device in responding to said call, the content of said second SIP message depending on the selection of said choices made by said callee.

2. The method of claim 1, wherein after said second communication device sends a SIP message to said first communication device, said first communication device presents or displays a plurality of choices at one or more navigating levels for said caller to select from, and then sends a SIP message back to the second communication device; said first communication device or said second communication device or both being a mobile phone device.

3. The method of claim 1, wherein said second communication device has a default communication channel and said plurality of choices in (b) include a default choice and, upon selecting said default choice, a call session is established in another SIP-enabled communication device having a default communication channel different from said default communication channel of said second communication device.

4. The method of claim 1, wherein after said callee's making a choice at one or more navigating levels in (b), a call session is established using a communication channel available in said second communication device which is different from its default communication channel.

5. The method of claim 1, wherein following said callee's making one or more choices in (b), one or more medium streams of the call session to be established are diverted to another communication device while the rest of said call session is established between said first communication device and said second communication device.

6. A method of improving communication following completion of the call-setup stage in a SIP-enabled communication network which comprises at least a first communication device being used by a caller and a second communication device having a set of communication channels and being used by end-user, comprising presenting or displaying on said devices a plurality of choices for call transfer at one or more navigating levels for said end-user to select from when said end-user decides to transfer an established call session.

7. The method of claim 6, wherein after said end-user's making a choice at one or more navigating levels, said call session is transferred to another SIP-enabled communication device having a set of communication channels identical to or different from said set of communication channels of said second communication devices.

8. The method of claim 6, wherein after said end-user's making a choice at one or more navigating levels, said call session is transferred to a different communication channel available in said second communication device.

9. The method of claim 6, wherein following said end-user's making one or more choices, one or more medium streams of said call is transferred to another communication device while said call session continues between said first communication device and said second communication device.

10. The method of claim 5, wherein said communication channel is a function unit in said communication device, rendering one or more medium streams recognizable or meaningful to human through a display panel or a speaker.

11. The method of claim 9, wherein said communication channel is a function unit in said communication device, rendering one or more medium streams recognizable or meaningful to human through a display panel or a speaker.

12. The method of claim 1, wherein after said callee's making one or more choices in (b), a third SIP message is sent from said second communication device to a communication device of a third party to invite said third party to join said call in a conference mode.

13. The method of claim 6, wherein after said callee's making one or more choices in (b), a third SIP message is sent from said second communication device to a communication device of a third party to invite said third party to join said call in a conference mode.

14. The method of claim 1, wherein (b) comprises presenting or displaying on said second communication device a plurality of first-level choices and further presenting or displaying a plurality of second-level choices upon said callee's selecting a choice of said first-level choices.

15. The method of claim 14, wherein said plurality of first-level choices offer an option of keeping said call to said second communication device or transferring to one or more of separate communication devices available to said callee.

16. The method of claim 15, wherein said plurality of second-level choices allow switching said call in part or in whole among various channels available on a device chosen by said callee to receive said call.

17. The method of claim 14, where (b) further comprises presenting or displaying on said second communication device a plurality of third-level choices upon said callee's selecting a choice of said second-level choices.

18. The method of claim 1, wherein said SIP-enabled communication network is of a type selected from the group consisting of 3G, GPRS, WiFi, WiMax, Broadband and LAN.

19. The method of claim 6, wherein said SIP-enabled communication network is of a type selected from the group consisting of 3G, GPRS, WiFi, WiMax, Broadband and LAN.

20. The method of claim 18, wherein said call contains one or more medium streams of a type selected from the group consisting of voice, video, instant message, document, whiteboard and network game.

21. The method of claim 19, wherein said call contains one or more medium streams of a type selected from the group consisting of voice, video, instant message, document, whiteboard and network game.

22. The method of claim 20, wherein said first communication device and said second communication device are an independently mobile phone or PDA.

23. The method of claim 21, wherein said first communication device and said second communication device are an independently mobile phone or PDA.

24. The method of claim 3, wherein said another communication device is of a type selected from the group consisting of desktop phone, mobile phone, PDA, desktop computer and laptop computer.

25. The method of claim 7, wherein said another communication device is of a type selected from the group consisting of desktop phone, mobile phone, PDA, desktop computer and laptop computer.
